(19) United States
(12) Patent Application Publication
(10) Pub. No.: US 2006/0099122 A1
(43) Pub. Date: May 11, 2006

(54) Method and device for generating mixtures of fluids in a boundary layer

(76) Inventor: Nikolaus M. Vida, Rekingen (CH)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/536,300

(22) PCT Filed: Nov. 25, 2003
(86) PCT No.: PCT/EP03/13241

§ 371 Date: Dec. 5, 2005

(30) Foreign Application Priority Data
Nov. 25, 2002 (EP) 02400050.7

(51) Int. Cl. B01D 53/94

(52) U.S. Cl. 423/212

(57) ABSTRACT

A method and a device to generate an area of a mixture of fluids by introducing media having at least a different physical or chemical property into a boundary layer of a surface using vortices are provided. The method and the device can be applied to moving vehicles or walls of containers surrounding streaming fluids, the fluids being especially mixtures of gases, liquids or combinations of gases and liquids.

### SPECIFICATION

### Field of the Invention

The invention concerns surface areas as boundary layers of surfaces of moving vehicles or walls of containers surrounding streaming fluids as mixtures of gases, liquids or combinations of gases and liquids.

### BACKGROUND OF THE INVENTION

In various applications flowing media play a significant role. These applications range from vehicles moving in air or in water to pumping or pipe line systems.

In most cases different media with different properties are involved. Various methods are known to shape devices with respect to flowing media so that certain effects are optimised. These methods usually are based on the principle to avoid the building of vortices in the flowing media.

From U.S. Pat. No. 6,349,734 B1 also a method is known which uses so-called Görtler vortices to extend the time a substance, provided as a mixture or a solution, remains in the near-wall region of a flow, thereby preventing fluid mixture in the boundary layer.

### SUMMARY OF THE INVENTION

Therefore, it is an object of the present invention to show a way how the mixture of fluids in a boundary layer of a surface can be improved.

The object of the invention is achieved in a surprisingly simple manner by a subject matter of one of the attached independent claims. Advantageous embodiments and refinements are defined in the respective dependent claims.

The invention teaches to use vortices to generate an area of a mixture of fluids by introducing media having at least a different physical or chemical property into a boundary layer of a surface.

In a preferred embodiment said different property of said media is reduced friction and said media are comprising gases, preferably air, and gas liquid mixtures.

In a further preferred embodiment said vortices are used for sucking bubbles from the surface of a vehicle, especially from the body and/or propeller of a ship, into an area of a vortex having reduced pressure to avoid an increase of cavitation.

In case of a propeller, especially in view of different pressure regimes on the both sides and different velocities of the propeller blades vortex generators adapted to the specific requirements of the respective location are used.

In a further preferred embodiment media are introduced into said boundary layer from an opening located in said surface or in the vicinity of said surface connecting a source of said media having less friction with the boundary layer.

Preferably, said vortices are self organizing tornado-like vortices generated according to a method and a device as claimed in EP 0 679 812 patent or in WO 97/04280. The complete content of EP 0 679 812 and WO 97/04280 is hereby incorporated into this application by reference.

Advantageously, said opening is located in a dimple defined in the surface of said part of said vehicle.

Exhaust gases can be used as gases if said opening communicates with an exhaust system of an engine of the vehicle and assists in evacuating exhaust gases.

In a further preferred embodiment said opening is in the neighborhood of catalytic substances and promotes a catalytic reaction of exhaust gases.

In a most preferred embodiment a plurality of dimples and openings are located at an outer surface of a ship.

To provide an improved performance, said plurality of dimples and openings comprises dimples of different shape adapted to the requirements of a special area of the surface.

In a further most preferred embodiment, said surface is part of a pipe line system especially of a petrol, mineral oil or fuel pipe line system and, advantageously, said gas or gas liquid mixture is comprising gases accumulated in the course of petrol exhaustion or production.

The invention further may be used as chemical pump and mixing system if the different physical property is the chemical composition. This pump system provides special advantages especially for systems containing aggressive or radio active components as wear of bearings and other movable parts is drastically reduced.

If the different physical property is the temperature, very reliable cooling systems can be realized.

In a more general manner the invention also teaches using said low pressure area of said vortices as a pumping means for pumping media from a higher to a lower pressure regime.

As a consequence of this more general aspect of the invention use as a nautical pump out system is proposed.

The inventive device uses vortices to generate an area of a mixture of fluids by introducing media having at least a different physical or chemical property into a boundary layer of a surface.

Advantageously the different physical or chemical property of the media is reduced friction and the media are comprising gases, preferably air, and gas liquid mixtures.

With special advantage the inventive device comprises means to suck bubbles from a surface into an area of a vortex having reduced pressure. Preferably the device comprises a being part is the surface of a vehicle, especially from the body and/or propeller of a ship. Any surface of any vehicle, along which at least one medium is flowing, also lies within the scope of the invention. The great advantage of means to suck bubbles from a surface into an area of a vortex having reduced pressure is that an increase of cavitation is avoided by that.

Preferably the device comprises means for introduction of the media into the boundary layer of a surface from an opening located in said surface or in the vicinity of said surface connecting a source of at least one medium with the boundary layer, preferably a source of said media having less friction.

With advantage the vortices generated by the device are self organizing tornado-like vortices. Self organizing tornado-like vortices can be generated according to a method and a device as claimed in EP 0 679 812 or in WO 97/04280.

With advantage the device comprises a surface with at least one opening located in at least one dimple defined in the surface, providing for the introduction of the media into the boundary layer of the surface from the opening, said surface being a surface of a vehicle or part of a vehicle.

Preferably said opening communicates with an exhaust system of an engine of a vehicle and assists in evacuating exhaust gases. With advantage said opening can be located in the neighborhood of catalytic substances, thus promoting a catalytic reaction of exhaust gases.

Advantageously said surface comprises a plurality of dimples and openings located at an outer surface of a vehicle, preferably a ship. The plurality of dimples and openings comprise preferably dimples of different shape adapted to the requirements of a special area of the surface.

It also lies within the scope of the invention to provide means in the device to exert electrical, magnetical and/or mechanical influences, by which vortices are generated.

The device can also be part of a pipe line system, especially of a petrol, mineral oil or fuel pipe line system. The mixture of fluids generated by the device by means of the vortices can be a gas or gas liquid mixture, preferably comprising gases accumulated in the course of petrol exhaustion or production.

The at least different physical or chemical property of the media can be preferably the chemical composition, the device being a chemical pump or mixing system or part thereof. An inventive pump system provides special advantages especially for systems containing aggressive or radio active components as wear of bearings and other movable parts is drastically reduced.

The at least different physical or chemical property of the media can also be preferably the temperature. In this case the device can be a cooling or air conditioning system.

Through the vortices medium flows in certain directions are built in the vicinity of the boundary layer of the surface, leading to a transport of bubbles or other particles away from the surface. This effect can also be very advantageous in cooling or air conditioning system, since freezing can be reduced.

The media differing in any other physical or chemical property can also be suitable for certain applications.

The device can also be a pump system or part thereof. A low pressure area generated by means of the vortices is in this case used as a pumping means for pumping media from a higher to a lower pressure regime. Further the device can also be a nautical pump out system or part thereof.

### DETAILED DESCRIPTION OF THE INVENTION

The invention together with several preferred embodiments will be better understood from the belowstanding detailed description in conjunction with the attached drawings wherein it is shown in:

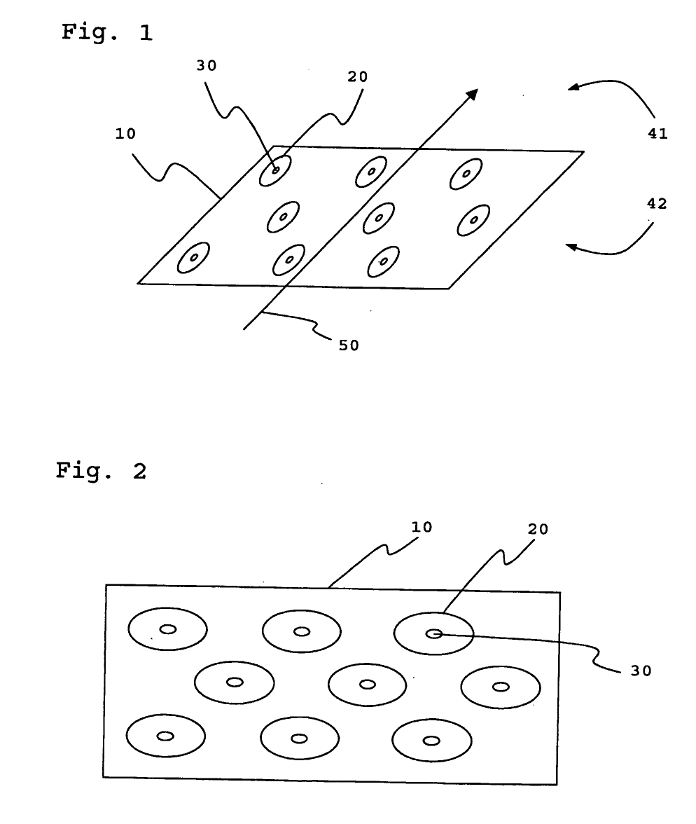

FIG. 1: a surface with dimples having openings with different media on the two sides of the surface

FIG. 2: a top view of a surface with dimples having openings

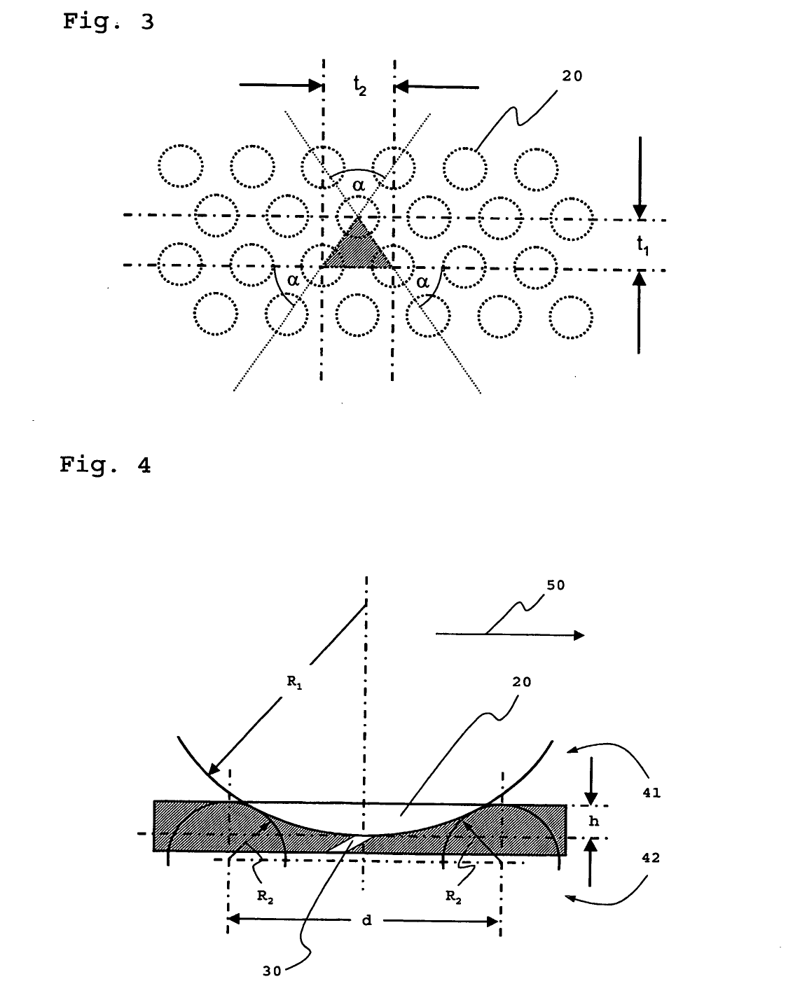

FIG. 3: a preferred distribution of dimples

FIG. 4: a cross section through a surface with dimples having openings

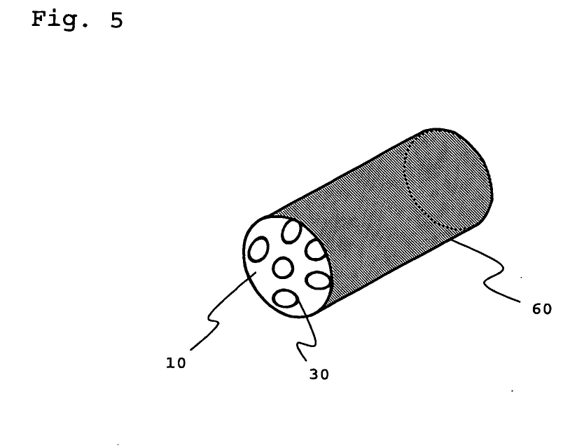

FIG. 5: a part of a pipe line system comprising dimples on the inner surface

FIG. 1 shows a surface 10 which is provided with dimples 20 having an opening 30. By means of the openings 30 the first side 41 and the second side 42 of the surface 10 are connected. Along the first side 41 of the surface 10 a first medium flows in the direction indicated by the arrow 50.

By means of the dimples 20 vortices are built in the boundary layer of the flowing first medium. The vortices generate an area of low pressure in the vicinity of the dimples 20.

That way a second medium, which is provided on the second side 42 of the surface 10 and has at least a different physical or chemical property with respect to the first medium, is sucked through the opening 30 to the first side 41 of the surface, thus generating an area of a mixture of the first and the second medium in the boundary layer of surface 10.

In FIG. 2 a possible distribution of dimples 20 on a surface 10 having openings 30 is shown schematically. In this embodiment the dimples 20 have an oval outline in the shown top view. In the cross section of the surface 10 the dimples 20 show concavities and convexities. Various other shapes of the dimples 20 also lie within the scope of the invention.

FIG. 3 shows a further preferred distribution of dimples on a surface. The dimples 20 in this embodiment have a circular outline and are arranged periodically on a surface. By the centers of three neighboring dimples an equilateral triangle is formed, angle α thus being 60°. The distance of the centers of two neighboring dimples 20 is t₂, the distance between two consecutive rows of dimples 20 is t₁. The values of t₁ and t₂ can vary depending on the application. The dimples 20 can be provided with openings connecting the two sides of the surface not shown in FIG. 3.

A cross section of a surface provided with dimples is shown schematically in FIG. 4. The dimple 20 in this embodiment shows a spherical surface with radius R₁, which is rounded at the edges by radii-forming with radius R₂, and has a height h and a diameter d. The dimples 20 in this example are symmetrical with respect to rotation with a rotation axis through the center of the dimple 20. The dimple 20 is located on a first side 41 of the surface 10 and is provided with an opening in the center adjoining a channel 30 by which a connection to the second side 42 of the surface is achieved.

The channel 30 is formed so that a second medium located on the second side 42 of the surface 10 can easily be sucked through the channel 30 to the first side 41 of the surface, when a first medium flows on the first side 41 of the surface in the direction indicated by arrow 50.

FIG. 5 shows a tube 60 which can be part of a pipe line system, especially of a petrol, mineral oil or fuel pipe line system. The tube 60 is provided with dimples 20 on the inner surface 10. The dimples may be provided with openings connecting the inside and outside area of the tube 60.

1. A method of generating mixtures of fluids in a boundary layer comprising:
using self organizing tornado-like vortices to generate an area of mixture of said fluids by introducing media having at least a different physical or chemical property into a said boundary layer of a surface.

2. The method according to claim 1, wherein said different physical or chemical property is reduced friction and said media comprise gases and/or gas liquid mixtures.

3. The method according to claim 1, wherein said surface comprises part of a vehicle, said vortices having reduced pressure to suck bubbles from said surface and avoid an increase of cavitation.

4. The method according to claim 2, wherein said media are introduced into said boundary layer from an opening located in said surface or in a vicinity of said surface connecting a source of said media having less friction with said boundary layer.

5. (canceled)

6. The method according to claim 4, wherein said opening is located in a dimple defined in said surface.

7. The method according to claim 4, wherein said opening communicates with an exhaust system of an engine of said vehicle and assists in evacuating exhaust gases.

8. The method according to claim 7, wherein said opening is in a region of catalytic substances and promotes a catalytic reaction of exhaust gases.

9. The method according to claim 1, further comprising providing a plurality of dimples and openings located at an outer surface of a ship to generate said area of mixture.

10. The method according to claim 9, wherein said plurality of dimples and openings comprises dimples having a shape adapted to of a special area of said surface.

11. The method according to claim 10, wherein said vortices are generated by electrical influences, magnetic influences, and/or mechanical influences.

12. The method according to claim 1, wherein said surface is part of a pipe line system.

13. The method according to claim 2, wherein said gas or gas liquid mixture is comprising gases accumulated in the course of petrol exhaustion or production.

14. The method according to claim 1, wherein said different physical property is chemical composition.

15. The method according to claim 1, wherein said different physical or chemical property is the temperature.

16. The method according to claim 1, further comprising using a low pressure area of said vortices for pumping media from a higher to a lower pressure regime.

17. The method according to claim 16, wherein said surface comprises a nautical pump out system.

18. A device comprising:
means for building self organizing tornado-like vortices to generate an area of a mixture of fluids by introducing media having at least a different physical or chemical property into a boundary layer of a surface.

19. The device according to claim 18, wherein said different physical or chemical property is reduced friction and said media comprises gases and/or gas liquid mixtures.

20. The device according to claim 18, further comprising means to suck bubbles from said surface of a vehicle into an area of a vortex having reduced pressure to avoid an increase of cavitation.

21. The device according to claim 18, further comprising means for introducing said media into said boundary layer from an opening located in said surface or in a vicinity of said surface connecting a source of said media having less friction with said boundary layer.

22. (canceled)

23. The device according to claim 20, further comprising an opening is located in a dimple defined in said surface of a part of said vehicle.

24. The device according to claim 20, further comprising an opening in communication with an exhaust system of an engine of said vehicle and assists in evacuating exhaust gases.

25. The device according to claim 24, wherein said opening is in a region of catalytic substances and promotes a catalytic reaction of exhaust gases.

26. The device according to claim 18, further comprising a plurality of dimples and openings located at an outer surface of a ship for building said self organizing tornado-like vortices.

27. The device according to claim 26, wherein said plurality of dimples and openings comprises dimples of having a shape adapted to of a special area of said surface.

28. The device according to claim 18, wherein said surface is part of a pipe line system.

29. The device according to claim 19, wherein said gas or gas liquid mixture is comprising gases accumulated in the course of petrol exhaustion or production.

30. The device according to claim 18, wherein said different physical or chemical property is chemical composition.

31. The device according to claim 18, wherein said different physical or chemical property is the temperature.

32. The device according to claim 18, wherein said low pressure area of said vortices find use as a pumping means for pumping media from a higher to a lower pressure regime.

33. The device according to claim 32, wherein said surface comprises a nautical pump out system.
